(19) United States
(12) Patent Application Publication
(10) Pub. No.: US 2011/0180015 A1
(43) Pub. Date: Jul. 28, 2011

(54) CHEW-PROOF LEASH AND COLLAR

(76) Inventor: Joslin Larson, Portland, OR (US)

(21) Appl. No.: 12/971,878

(22) Filed: Dec. 17, 2010

Related U.S. Application Data
(60) Provisional application No. 61/287,546, filed on Dec. 17, 2009.

(51) Int. Cl. A01K 27/00

(52) U.S. Cl. 119/792; 119/863; 119/795

(57) ABSTRACT

In one embodiment, a chew-proof animal collar is provided. The collar includes a collar body portion having two or more lengths of wire rope that have a first end with a swaged termination that is attached to a fastener and a second end with a swaged termination that is attached to an acceptor. The acceptor engages the fastener wherein the engagement between the acceptor and fastener is adjustable. In another embodiment, a chew-proof animal leash is provided. The leash has a leash body portion having a length of wire rope, an owner end with a swaged termination that is attached to a carabiner, wherein the carabiner is attached to a handle, and an animal end wherein the animal end has a swaged termination that is attached to a swiveled snap-hook.

### PRIORITY CLAIM

This application claims the benefit of U.S. Provisional Application No. 61/287,546, filed Dec. 17, 2009, the subject matter of which is hereby incorporated by reference as if fully set forth herein.

### BACKGROUND

Animal collars and leashes are used by owners for various purposes including walking, training, or restraining animals. Typically, collars and leashes are made from nylon, leather, or other similar flexible material. These types of leashes and collars can break during training, due to old age or if the animal is particularly strong and pulls on the leash.

Further, some animals, such as teething puppies or dogs that are “problem chewers,” often chew on their own leashes or the leashes and collars of other animals in the same household. If an animal chews even part-way through a leash or collar, it becomes especially vulnerable to breaking. If an animal that is being walked or otherwise controlled by such a leash pulls too hard or gets excited and suddenly tries to run toward another animal (e.g., a squirrel, a cat, another dog) or person, the compromised leash can break, potentially putting the animal (and others) at risk of getting hit by a car or other potential dangers.

### SUMMARY

According to one embodiment, a chew-proof animal collar is provided, including a collar body portion having two or more lengths of wire rope; a first end, wherein the first end has a swaged termination that is attached to a fastener; and a second end, wherein the second end has a swaged termination that is attached to an acceptor that engages the fastener, and wherein the engagement between the acceptor and fastener is adjustable.

In some embodiments, the two or more lengths of wire rope are arranged in parallel. In another embodiment, the collar body portion comprises three lengths of wire rope in a braided arrangement.

In some embodiments, the swaged termination of the chew-proof animal collar is a thimbled loop with a swaged sleeve. In another embodiment, the swaged termination of the chew-proof animal collar is a socket termination.

In some embodiments, the fastener that is attached to the first end swaged termination of the chew-proof collar is a swiveled snap-hook or a carabiner, and the acceptor that is attached to the second end swaged termination of the chew-proof collar is a welded link chain.

According to another embodiment, a chew-proof animal leash is provided, including a leash body portion having a length of wire rope; an owner end, wherein the owner end has a swaged termination that is attached to a carabiner and wherein the carabiner is attached to a handle; and an animal end, wherein the animal end has a swaged termination that is attached to a swiveled snap-hook.

In some embodiments, the swaged termination of the chew-proof animal leash is a thimbled loop with a swaged sleeve. In other embodiments, the swaged termination of the chew-proof animal leash is a socket termination. Further, in some aspects, the owner end has a carabiner swaged socket termination and the animal end has a swiveled snap-hook swaged socket termination.

In some embodiments, the swiveled snap-hook at the animal end of the chew-proof animal leash may be removably attached to an animal collar or harness. In one embodiment, the animal collar or harness is a chew-proof animal collar as described herein. In another embodiment, the swiveled snap-hook at the animal end of the chew-proof animal leash may be removably attached to a multiple animal attachment having two or more extensions.

Other features and advantages will appear hereinafter. The features described above can be used separately or together, or in various combinations or one or more of them.

### BRIEF DESCRIPTION OF THE DRAWINGS

In the drawings, wherein the same reference number indicates the same element throughout the views:

FIG. 1 is a perspective view of a chew-proof animal collar according to one embodiment of the disclosure.

FIG. 2 is a perspective view of a chew-proof animal collar wherein the collar body portion has three lengths of wire rope in a braided arrangement.

FIG. 3 is a perspective view of a thimbled loop with a swaged sleeve that may be used as a swaged termination according to embodiments of the disclosure.

FIG. 4A is a perspective view of a carabiner swaged socket termination according to embodiments of the disclosure.

FIG. 4B is a perspective view of another carabiner swaged socket termination according to embodiments of the disclosure.

FIG. 5A is a perspective view of a swiveled snap-hook swaged socket termination according to embodiments of the disclosure.

FIG. 5B is a perspective view of another swiveled snap-hook swaged socket termination according to embodiments of the disclosure.

FIGS. 6A and 6B are perspective views of first and second ends of a chew-proof animal collar according to one embodiment of the disclosure. FIG. 6A is a perspective view of a first end of a chew-proof animal collar having a swaged termination that is attached to a buckle. FIG. 6B is a perspective view of a second end of a chew-proof animal collar having a swaged termination that comprises a series of swaged buckle rests that are accepted by the buckle.

FIG. 7 is a perspective view of a chew-proof animal leash according to one embodiment of the disclosure.

FIG. 8 is a perspective view of a chew-proof animal leash according to another embodiment of the disclosure.

FIG. 9 is a perspective view of a chew-proof animal leash, illustrating the conversion of the full-length leash to a chew-proof traffic lead according to one embodiment of the disclosure.

FIG. 10 is a perspective view of a chew-proof animal leash, illustrating its use as a tether according to one embodiment of the disclosure.

FIG. 11A is a perspective view of a multiple animal attachment according to one embodiment of the disclosure.

FIG. 11B is a perspective view of a multiple animal attachment having non-swiveled snap-hook swaged sockets attached to the O-Ring according to embodiments of the disclosure.

FIG. 12 is a perspective view of a non-swiveled snap-hook swaged socket termination according to embodiments of the disclosure.

### DETAILED DESCRIPTION

Various embodiments will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments. Certain terms may even be emphasized below; however, any terminology intended to be interpreted in any restricted manner will be overly and specifically defined as such in this detailed description section.

Where context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

The chew-proof leash and collar combination described herein may be used by a pet owner to prevent the pet (or another animal) from chewing through the collar or leash, or to otherwise prevent the collar or leash from breaking due to the strength of an animal or age of the leash or collar. According to embodiments of the disclosure, a chew-proof collar or chew-proof leash may be made from wire rope that can withstand animal chewing. The wire rope may be of variable breaking strength, based on the strength of the animal with which it is designed to be used. Generally, wire rope having a breaking strength of 900 pounds is sufficient for use according to the current disclosure. Any other suitable breaking strength may be used, though.

To enable the ends of the wire rope or ropes that make up the body of the chew-proof collar or leash to be attached to other components of the chew-proof leash and collar, the ends may have any type of termination that allows other components to be attached to the body of the leash or collar. In a preferred embodiment, the terminations are swaged terminations.

The swaged terminations that are found at the ends of the chew-proof collar are associated with or attached to various complementary fastening devices that are adjustable according to the size of the animal's neck.

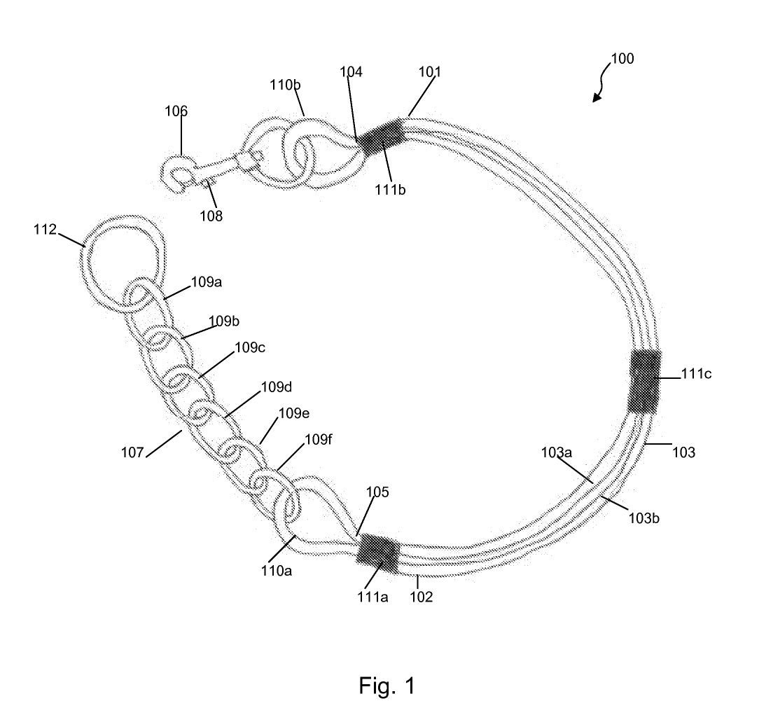

Turning now to the drawings, as shown in FIG. 1, a chew-proof collar 100 according to one embodiment has a collar body portion 103 having two lengths of wire rope in parallel 103a, 103b having a first end 101 and a second end 102. The first end 101 has a swaged termination 104 that is attached to a swiveled snap-hook 106, and the second end 102 has a swaged termination 105 that is attached to a welded link chain 107.

The chew-proof collar 100 is placed around an animal's neck and secured by opening the swiveled snap-hook 106 by pushing down on a spring-loaded safety latch 108 and attaching the open swiveled snap-hook 106 on an appropriate link of the welded link chain 107, such that the collar fits the dog's neck. The welded link chain 107 may include multiple links 109a, 109b, 109c, 109d, 109e, 109f to make the chew-proof collar 100 adjustable to different sizes of pets. The chew-proof collar 100 in FIG. 1 includes six links 109a, 109b, 109c, 109d, 109e, 109f, but any number of links may be used to accommodate different sizes of pets. In one aspect, the welded link chain 107 ends with an O-ring 112 that may be used as an attachment point for a restraining device such as a leash, lead or tether. In one aspect, the leash used with the chew-proof collar is the chew-proof leash described below.

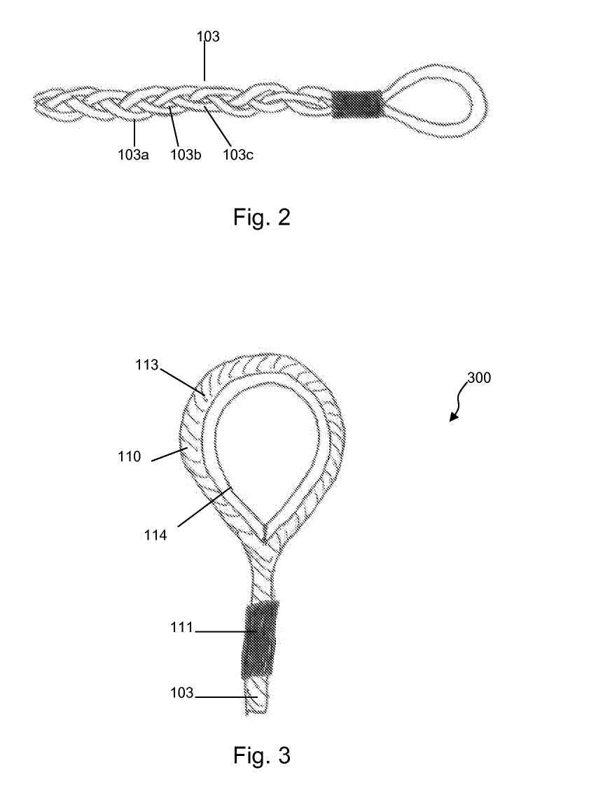

In another embodiment as shown in FIG. 2, the collar body portion 103 of the chew-proof collar 100 has three lengths of wire rope 103a, 103b, 103c in a braided configuration. In both the parallel and braided configurations, each length of wire rope is preferably coated with a polyvinyl or other suitable plastic coating to protect the wire and any object, pet, or person from damage or injury. The coating may have one or more translucent or opaque colors that can be patterned or solid to provide an aesthetically pleasing collar.

The first and second ends 101, 102 can have various types of swaged terminations 104, 105, including, but not limited to, thimbled loops, swaged sleeves, ferrules, threaded studs, swaged sockets, or any combination thereof. In the embodiment shown in FIG. 1, the first and second ends 101, 102 are terminated with a thimbled loop 110a, 110b and a swaged sleeve (or ferrule) 111a, 111 b. One or more additional swaged sleeves 111c may be used to hold the lengths of wire rope 103a, 103b together, as a decorative element, or for any other functional or aesthetic use.

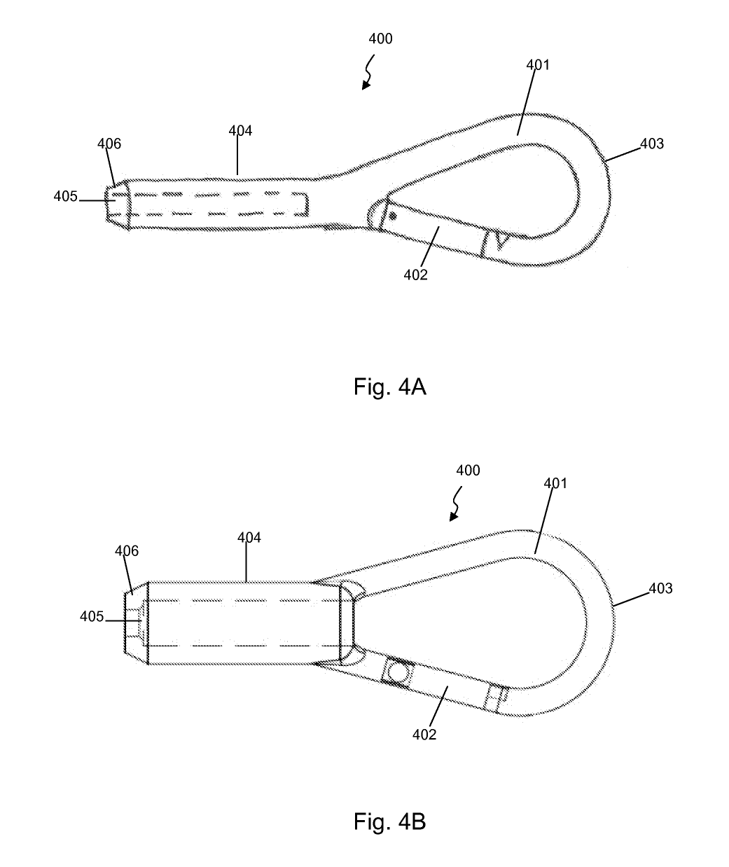

FIG. 3 shows a thimbled loop 110 with a swaged sleeve 111 that may be used as a swaged termination 300 according to one embodiment. When a length of wire rope 103 is terminated with a wire rope loop 113, there is a risk that it will bend too tightly, especially when the loop is connected to a device such as the swiveled snap-hook 106 (as shown in FIG. 1) that spreads a load over a relatively small area. A thimble 114 can be installed inside of the loop to preserve the natural shape of the loop, and to protect the wire rope on the inside of the wire rope loop 113. The thimble 114 prevents the swiveled snap-hook 106 from coming into direct contact with the inner wire rope.

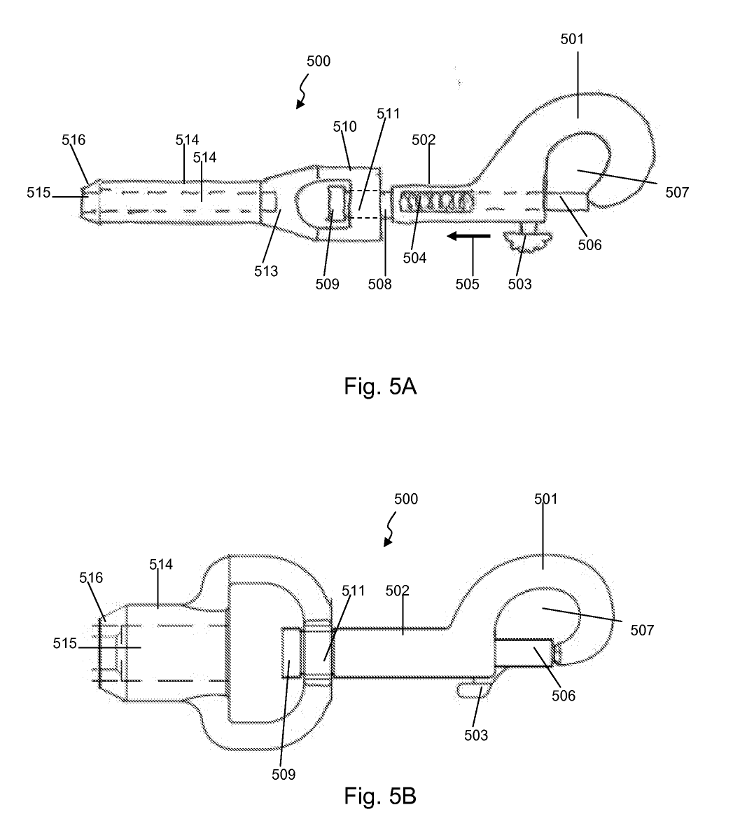

In another embodiment, the first and second swaged ends 101, 102 can be terminated with a swaged socket (or threaded stud). Production of the chew-proof collars and leashes described herein is made more efficient and cost effective by incorporating swaged socket terminations. A carabiner swaged socket termination 400 according to embodiments of the disclosure, as shown in FIGS. 4A and 4B, has a body member 401 and a spring-loaded hinged gate 402 that, when in resting position, together form a closed loop 403. The spring-loaded hinged gate 402 can pivot inward to open the closed loop 403 in order to removably attach the carabiner swaged socket termination 400 to another object. Integrally extending from the closed loop 403 is an elongated tubular portion 404 with a tapered end 406 having an opening 405 that extends along the length of the tubular portion 404 and that receives an end portion of wire rope. The opening 405 may have a diameter that varies based on the gauge of wire rope that is selected. In some embodiments, the opening 405 may have a diameter between approximately 3 mm to approximately 11 mm, or any other suitable diameter. In one embodiment, the opening 405 may have a diameter of approximately 3.1 mm. In another embodiment, the opening 405 may have a diameter of approximately 3.5 mm. In another embodiment, the opening 405 may have a diameter or approximately 6 mm. In yet another embodiment, the opening 405 may have a diameter of approximately 10.2 mm. The carabiner swaged socket termination 400 may be made from any malleable material suitable for a swaged socket. In one embodiment, the material may be malleable grade aluminum or steel.

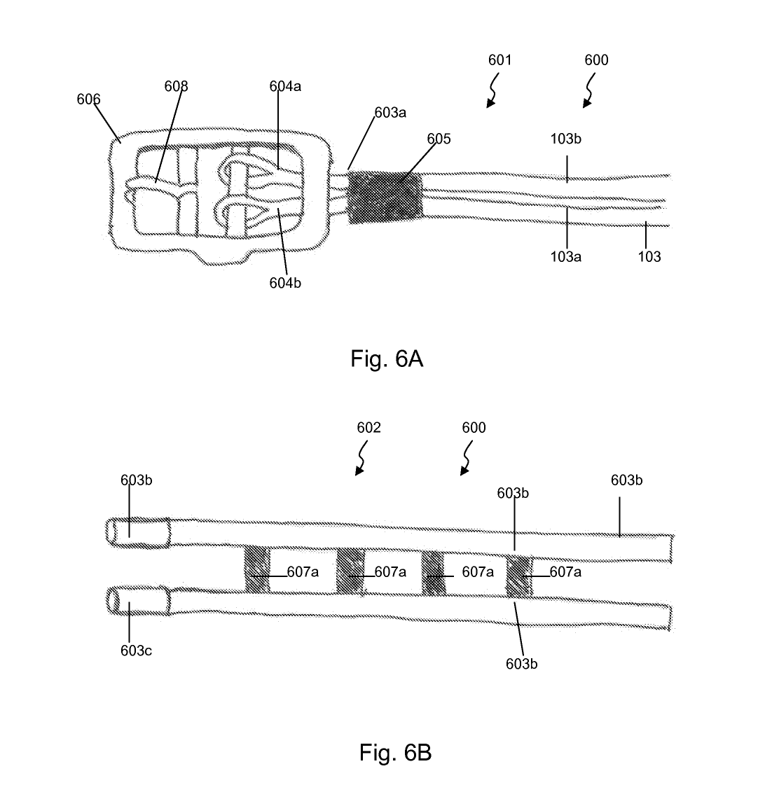

A swiveled snap-hook swaged socket termination 500 according to embodiments of the disclosure, as shown in FIGS. 5A and 5B, has a hook member 501 with a cylindrical end 502 that houses a spring 504. The spring 504, in its resting state, applies tension on a safety latch 506, such that the safety latch closes off a hook aperture 507. The safety latch 506 is attached to a spring-loaded tang 503. When the spring-loaded tang 503 is pushed in the direction of the arrow 505, the spring 504 is compressed and the attached safety latch 506 also moves in the direction of the arrow 505 so as to open the hook aperture 507 in order to removably attach the swiveled snap-hook swaged socket termination 500 to another object. Integrally extending from the cylindrical end 502 of the hook member 501 is a shaft 508, terminating in a bolt 509. The shaft extends through a bore 511 (not shown) in a hook receiver 510 such that the shaft 508 will rotate freely within the bore 511. The hook receiver 510 is attached to a tapered adaptor 513, which has an elongated tubular portion 514 with a tapered end 516 that integrally extends therefrom. The elongated tubular portion 514 has an opening 515 that extends along the length of the tubular portion 514 and that receives an end portion of wire rope. The opening 515 may have a diameter that varies based on the gauge of wire rope that is selected. In some embodiments, the opening 515 may have a diameter between approximately 3 mm to approximately 11 mm, or any other suitable diameter. In one embodiment, the opening 515 may have a diameter of approximately 3.1 mm. In another embodiment, the opening 515 may have a diameter of approximately 3.5 mm. In another embodiment, the opening 515 may have a diameter or approximately 6 mm. In yet another embodiment, the opening 515 may have a diameter of approximately 10.2 mm. The swiveled snap-hook swaged socket termination 500 may be made from any malleable material suitable for a swaged socket. In one embodiment, the material may be malleable grade steel or aluminum.

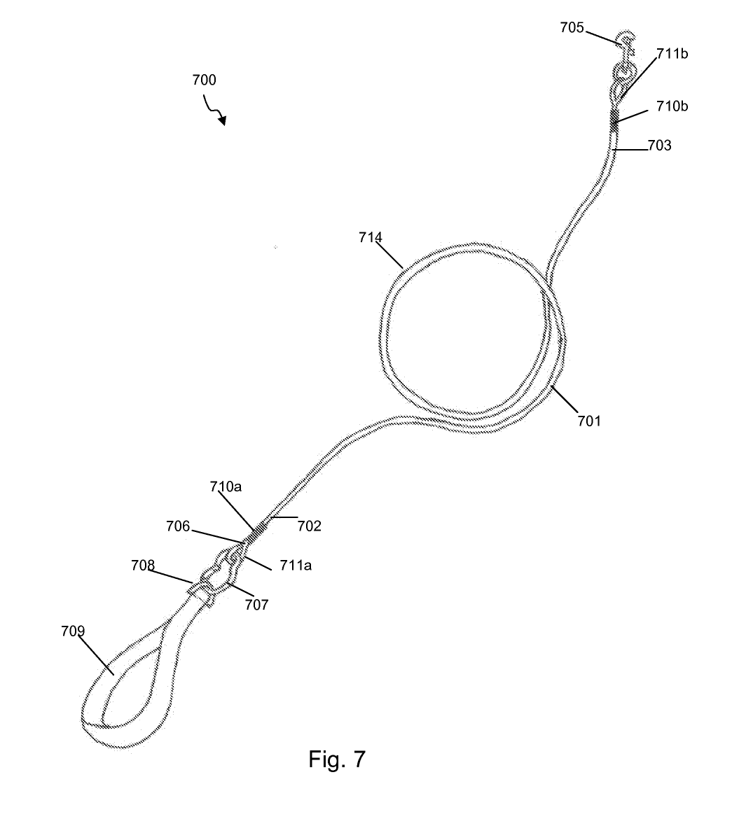

According to another embodiment as shown in FIGS. 6A and 6B, a chew-proof collar 600 includes two lengths of wire rope 103a, 103b in parallel having a first end 601 and a second end 602. The first end 601, shown in FIG. 6A, has a swaged termination 603a. The swaged termination 603a can be a thimbled loop 604a, 604b with a swaged sleeve 605, wherein the thimbled loops 604a, 604b are attached to a buckle 606 (FIG. 6A). The second end 602, shown in FIG. 6B, has one or more swaged buckle rests 607a, 607b, 607c, 607d that are made from a series of swaged sleeves or ferrules attached to the lengths of wire rope 103a, 103b at each end. The swaged buckle rests 607a, 607b, 607c, 607d are oriented perpendicularly to the lengths of wire rope, with each end of each buckle rest attached to a length of wire rope 103a, 103b. Each individual end of the two lengths of wire rope 103a, 103b in parallel that make up the collar body 103 may have decorative swaged terminations 603b, 603c. The buckle 606 on the first swaged end 601 has a tongue 608 that rests on a swaged buckle rest 607a, 607b, 607c, 607d such that the chew-proof collar is secured around the animal's neck.

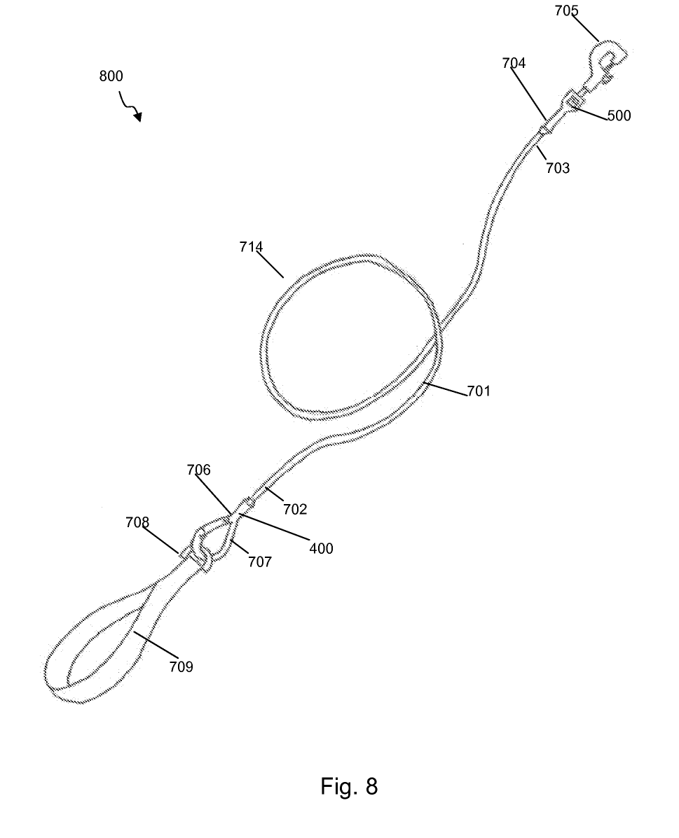

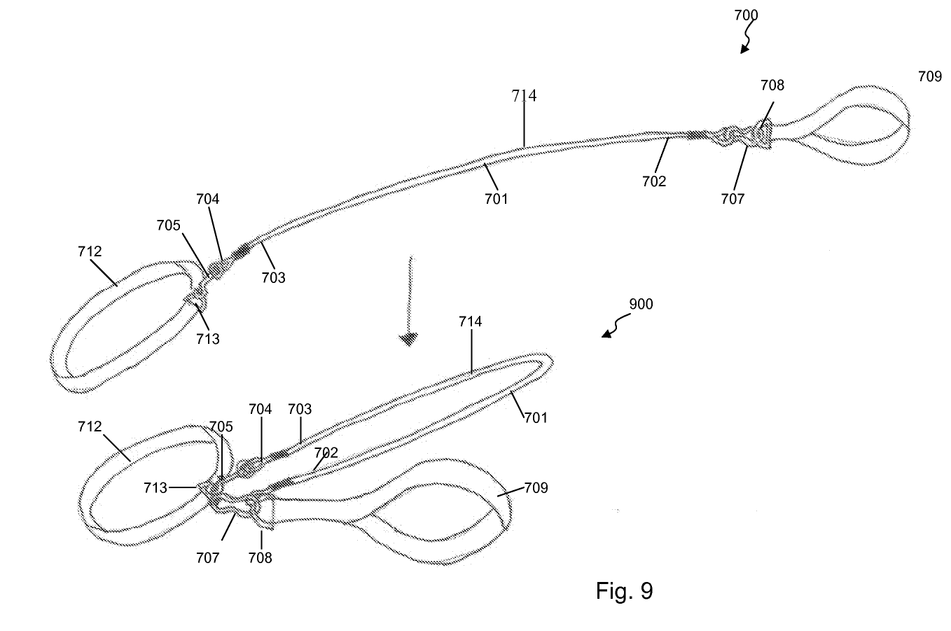

As shown in FIGS. 7 and 8, a chew-proof leash 700, 800 (FIGS. 7 and 8, respectively) according to embodiments of the disclosure has a leash body portion 714 comprising a wire rope 701 having an owner end 702 and an animal end 703. The length of the wire rope may vary, based on, among other factors, the intended use, the size of the dog, or the height of the owner. For example, a chew-proof animal leash may have a body portion having a length of wire rope that is between approximately 48-72 inches for a standard training or walking leash according to one embodiment. In another embodiment, a chew-proof animal leash may have a length of wire rope that is between approximately 23-36 inches, wherein the leash is to be used as a traffic lead. Any other suitable length leash may be used.

The wire rope 701 may be coated with a polyvinyl or other suitable plastic coating to protect the wire and any object, pet, or person from damage or injury. The coating may have one or more translucent or opaque colors that may be patterned or solid to provide an aesthetically pleasing leash.

The animal end 703 has a swaged termination 704 that is attached to a swiveled snap-hook 705 that can be removably attached to an animal collar or harness. In one embodiment, the animal collar is the chew-proof animal collar described above. The owner end 702 has a swaged termination 706 that is attached to a carabiner 707, which is in turn attached to a handle 709 by way of a D-ring 708 or other suitable connector. The handle 709 may be made from nylon, leather, or another material suitable for a hand strap.

The owner end 702 and animal end 703 may have various types of swaged terminations. FIG. 7 shows one embodiment wherein the owner and animal ends have swaged terminations comprising a thimbled loop 711a, 711b and a swaged sleeve (or ferrule) 710a, 710b. Such a thimbled loop and swaged sleeve is described in detail above, and shown in FIG. 3. FIG. 8 shows another embodiment wherein the owner end has a carabiner swaged socket termination 400 and the animal end has a swivel snap-hook swaged termination 500. Such a carabiner swaged socket termination 400 and swivel snap-hook swaged termination 500 are described in detail above and shown in FIGS. 4A-B and 5A-B.

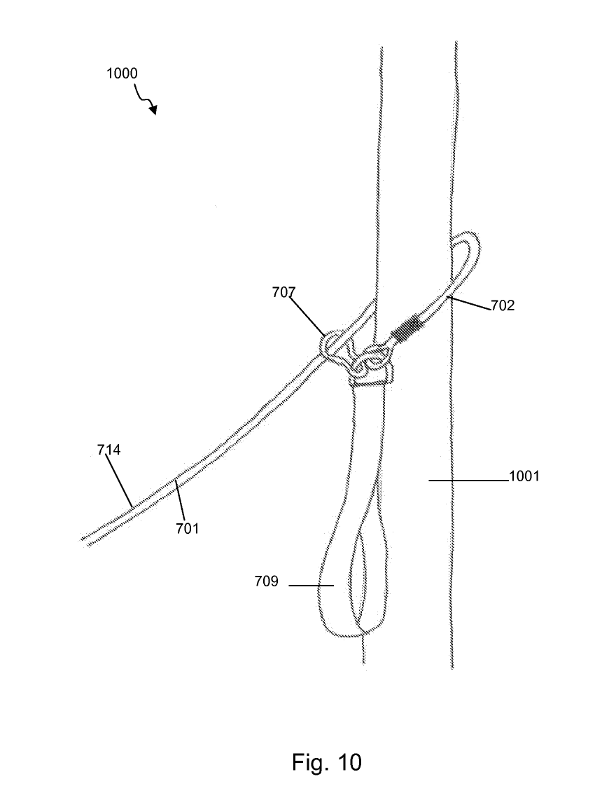

A chew-proof leash 700 according to some embodiments may be converted to a traffic lead. A traffic lead is a short leash that gives more control over an animal when in a busy area or when training an animal to heel. For example, a standard chew-proof leash 700 can be converted to a chew-proof traffic lead 900 as illustrated in FIG. 9. According to one embodiment, the chew-proof leash may be as described above in accordance with the embodiment shown in FIG. 7 (but is not limited to such a configuration) having a leash body portion 714 comprising a wire rope 701 and having an owner end 702 and an animal end 703. The animal end 703 has a swaged termination 704 that is attached to a swiveled snap-hook 705 that may be removably attached to an animal collar 712 by way of a collar D-ring 713 or other attachment such as an O-ring. With the swiveled snap-hook 705 of the animal end 703 of the chew-proof leash 700 removably attached to the animal collar, the owner may then removably attach the carabiner 707 of the owner end 702 of the chew-proof leash 700 to the animal collar 712, thereby creating a short traffic lead 900.

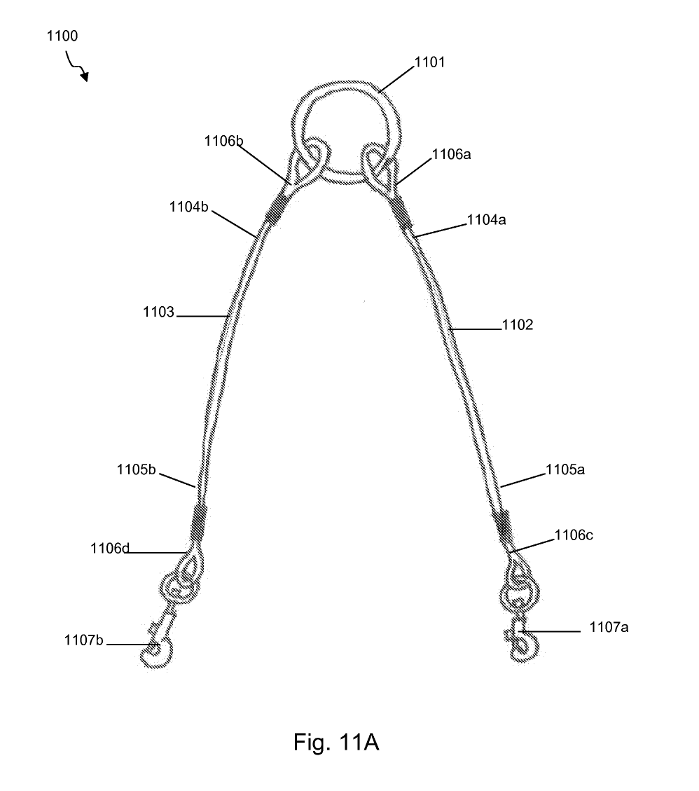

Further, the chew-proof leash 700 described above may be converted to a tethering device 1000, as illustrated in FIG. 10. When an owner takes an animal for a walk using a chew-proof leash 700 as described herein, and wants to enter a store or other area that the animal is not allowed, the owner end 702 of the chew-proof leash 700 may be wrapped around a tree, pole, post, or other object 1001 and secured by removably attaching the carabiner 707 of the owner end 702 to the wire rope 701 of the leash body portion 714. The handle 709 is removable from the carabiner 707 so that it may be removed and put away, out of reach of the pet. For example, when tethering the animal to an object 1001, the handle may be removed so that, while tethered and out of the owner's sight, the pet does not chew through the handle.

In another embodiment, the chew-proof leash 700 may be tethered to the owner's waist in order to provide a hands-free, chew-proof leash for use while running or walking with hands occupied (not shown).

A chew-proof leash 700 according to FIGS. 7 and 8 may have one or more attachments. The attachments may be permanently or non-permanently attached, and may be attached at the pet end 703 to the swiveled snap-hook 705 or at the owner end 702 to the D-ring 708 or carabiner 707. Examples of attachments that may be used are as follows: pet waste bag dispenser and bags, treat pouch or other pouch for holding keys, identification, money, credit cards, or other small items while walking an animal, or a multiple animal walker.

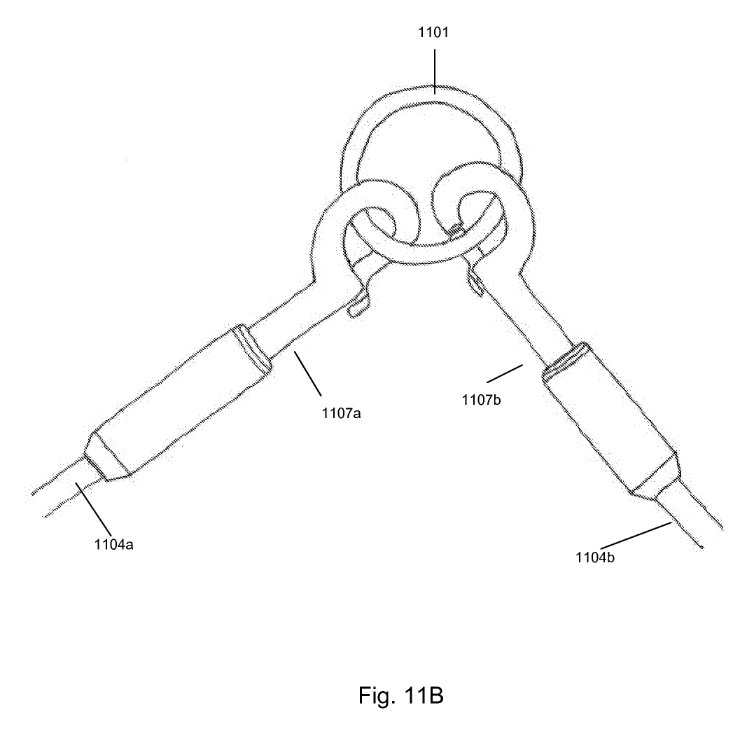

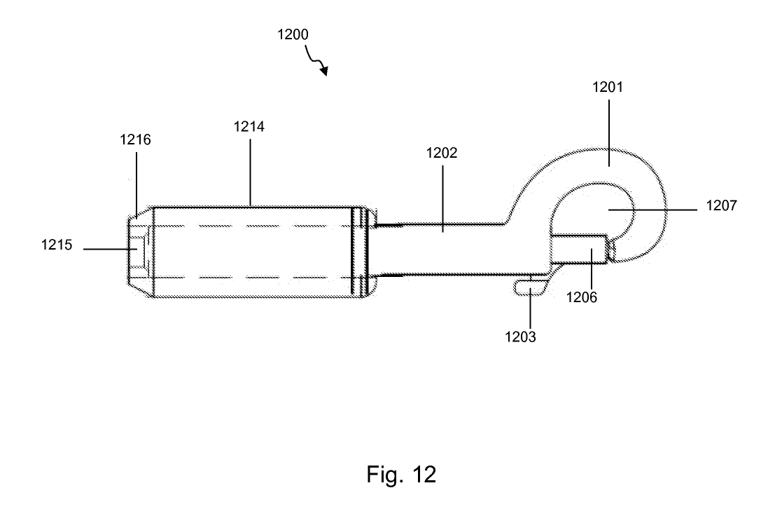

A multiple animal walker 1100 that may be used when someone wants to walk two or more animals at the same time is shown in FIG. 11A. The swiveled snap-hook 705 of the owner end 703 attaches to an O-ring 1101. The O-ring has two attached extensions 1102, 1103 preferably made of wire rope. The extensions 1102, 1103 each have a leash end 1104a, 1104b and a collar end 1105a, 1105b that optionally have swaged terminations 1106a, 1106b, 1106c, 1106d. The swaged terminations 1106a, 1106b, 1106c, 1106d may be thimbled loops with swaged sleeves or any other suitable swaged terminations. In some embodiments, the swaged terminations 1106c, 1106d at the collar ends 1105a, 1105b are attached to swiveled snap-hooks 1107a, 1107b. In one embodiment (not shown), the swaged terminations 1106c, 1106d are swaged socket snap-hooks such as those shown in FIGS. 5A, 5B and 12 (described below).

Although the multiple animal walker shown in FIG. 11A has two extensions for walking two animals at the same time, the multiple walker may have more than two extensions to walk more than two animals. In one embodiment, the leash ends 1104a, 1104b are attached to the O-ring 1101 by a swaged socket snap-hook 1107a, 1107b, as shown in FIG. 11B. This allows the number of extensions of the multiple animal walker to be reversibly modified.

The swaged socket snap-hook may be a swaged socket swiveled snap-hook such as those shown in FIGS. 5A and 5B, or may be a non-swiveled snap-hook 1200 as shown in FIG. 12. The non-swiveled snap-hook 1200 has a hook member 1201 with a cylindrical end 1202 that houses a spring. The spring, in its resting state, applies tension on a safety latch 1206, such that the safety latch closes off a hook aperture 1207. The safety latch 1206 is attached to a spring-loaded tang 1203. Integrally extending from the cylindrical end 1202 of the hook member 1201 is an elongated tubular portion 1214 with a tapered end 1216 that integrally extends therefrom. The elongated tubular portion 1214 has an opening 1215 that extends along the length of the tubular portion 1214 and that receives an end portion of wire rope. The opening 1215 may have a diameter that varies based on the gauge of wire rope that is selected. In some embodiments, the opening 1215 may have a diameter between approximately 3 mm to approximately 11 mm, or any other suitable diameter. In one embodiment, the opening 1215 may have a diameter of approximately 3.1 mm. In another embodiment, the opening 1215 may have a diameter of approximately 3.5 mm. In another embodiment, the opening 1215 may have a diameter or approximately 6 mm. In yet another embodiment, the opening 1215 may have a diameter of approximately 10.2 mm. The swiveled snap-hook swaged socket 1200 may be made from any malleable material suitable for a swaged socket. In one embodiment, the material may be malleable grade steel or aluminum.

Any of the above-described embodiments may be used alone or in combination with one another. Furthermore, the chew-proof collar and leash may include additional embodiments or features not described herein. While several embodiments have been shown and described, various changes and substitutions may of course be made, without departing from the spirit and scope of the invention. The invention, therefore, should not be limited, except by the following claims and their equivalents.

What is claimed is:

1. A chew-proof animal collar, comprising:
a collar body portion comprising wire rope;
a first end, wherein the first end has a swaged termination that is attached to a fastener; and
a second end, wherein the second end has a swaged termination that is attached to an acceptor that engages the fastener, wherein the engagement between the acceptor and the fastener is adjustable.

2. The chew-proof animal collar of claim 1, wherein two or more lengths of the wire rope are arranged in parallel.

3. The chew-proof animal collar of claim 1, wherein the collar body portion comprises three lengths of the wire rope in a braided arrangement.

4. The chew-proof animal collar of claim 1, wherein the swaged termination is a thimbled loop with a swaged sleeve.

5. The chew-proof animal collar of claim 1, wherein the swaged termination is a socket termination.

6. The chew-proof animal collar of claim 1, wherein the fastener is a swiveled snap-hook.

7. The chew-proof animal collar of claim 1, wherein the fastener is a carabiner.

8. The chew-proof animal collar of claim 1, wherein the acceptor is a welded link chain.

9. A chew-proof animal leash, comprising:
a leash body portion, comprising wire rope;
an owner end, wherein the owner end has a swaged termination that is attached to a carabiner and wherein the carabiner is attached to a handle; and
an animal end, wherein the animal end has a swaged termination that is attached to a swiveled snap-hook.

10. The chew-proof animal leash of claim 9, wherein the wire rope is between approximately 48-72 inches long.

11. The chew-proof animal leash of claim 9, wherein the wire rope is between approximately 23-36 inches long.

12. The chew-proof animal leash of claim 9, wherein the swaged termination is a thimbled loop with a swaged sleeve.

13. The chew-proof animal leash of claim 9, wherein the swaged termination is a socket termination.

14. The chew-proof animal leash of claim 9, wherein the owner end has a carabiner swaged socket termination.

15. The chew-proof animal leash of claim 9, wherein the animal end has a swiveled snap-hook swaged socket termination.

16. The chew-proof animal leash of claim 9 wherein the swiveled snap-hook is configured to be removably attached to an animal collar or harness.

17. The chew-proof animal leash of claim 9, wherein the swiveled snap-hook is configured to be removably attached to a multiple animal walker attachment having two or more animal extensions.

18. A chew-proof animal collar and leash assembly, comprising:
a chew-proof animal collar, the chew-proof collar comprising:
a collar body portion comprising wire rope;
a first end, wherein the first end has a swaged termination that is attached to a fastener; and
a second end, wherein the second end has a swaged termination that is attached to an acceptor that engages the fastener, wherein the engagement between the acceptor and the fastener is adjustable;
a chew-proof animal leash, the chew-proof animal leash comprising:
a leash body portion, comprising wire rope;
an owner end, wherein the owner end has a swaged termination that is attached to a carabiner and wherein the carabiner is attached to a handle; and
an animal end, wherein the animal end has a swaged termination that is attached to a swiveled snap-hook.

19. The chew-proof animal collar and leash assembly of claim 9, wherein the owner end has a carabiner swaged socket termination.

20. The chew-proof animal collar and leash assembly of claim 9, wherein the animal end of the leash has a swiveled snap-hook swaged socket termination.
